(19) United States
(12) Patent Application Publication
(10) Pub. No.: US 2026/0238350 A1
(43) Pub. Date: Aug. 13, 2026

(54) QUANTUM COMMUNICATION SYSTEM USING CORRECTION OF THE POLARIZATION OF PHOTONS

(71) Applicant: THALES, MEUDON (FR)

(72) Inventors: Raphaël AYMERIC, TOULOUSE (FR); Michel SOTOM, TOULOUSE (FR); Mathieu BERTRAND, TOULOUSE (FR)

(21) Appl. No.: 18/988,739

(22) Filed: Dec. 19, 2024

(30) Foreign Application Priority Data
Dec. 21, 2023 (FR) 2314818

(51) Int. Cl. H04B 10/70; H04B 10/61

(52) U.S. Cl. CPC H04B 10/70; H04B 10/61

(57) ABSTRACT

A receiver is provided for receiving a multiplexed signal and an optical signal that are transmitted independently through a transmission channel, the multiplexed signal including a first quantum signal (Qₙ) and at least one polarization state control signal, the optical signal including a second quantum signal (Qₕ), the receiver having a processing chain and a correlation module associated with a polarization base of at least one polarization state, the chain being designed to determine the polarization state of the control signal and to modify the polarization of the multiplexed signal so as to align the determined state with the state of the base, the module being configured to carry out a correlation measurement between the first and second quantum signals and to generate, based on the measurement, at least one information signal regarding the entanglement state of the first and second quantum signals.

### CROSS-REFERENCE TO RELATED APPLICATION

This application claims priority to foreign French patent application No. FR 2314818, filed on Dec. 21, 2023, the disclosure of which is incorporated by reference in its entirety.

### FIELD OF THE INVENTION

The present invention relates in general to quantum telecommunications, and in particular to a transmitter for transmitting optical signals comprising entangled quantum signals, to a receiver for receiving optical signals comprising quantum signals, and to a system comprising such transmitters and receivers, and to the associated methods that are implemented.

### BACKGROUND

The main application of current quantum telecommunications systems is that of using quantum information theory to distribute a cryptographic key (or encryption key) between two telecommunications devices (that is to say two users), via specific quantum protocols, with the aim of subsequently encrypting the communications between these two devices in a secure manner. The secret cryptographic keys that are obtained have a higher degree of security than keys obtained using conventional protocols.

In a quantum telecommunications system, the two users may be too far apart physically to simply use the usual steps of QKD (quantum key distribution) quantum protocols to share such an encryption key. In this context, quantum-state-teleportation and entanglement-sharing quantum protocols make it possible to link two distant quantum devices with one another in order to share an encryption key.

Such quantum-state-teleportation and entanglement-sharing quantum protocols consist in making quantum particles interfere with one another, said quantum particles originating from two entangled quantum signals, each particle belonging to an entangled pair of quantum particles.

The information used to generate an encryption key is obtained by measuring an encoding variable of the quantum particles (also called “qubits”), generally corresponding to photons, which has been encoded beforehand. This encoding variable has a random value but is identical for both entangled particles, thereby making it possible to share the same information. An encoding variable of a qubit corresponds to a degree of freedom of the quantum particle and may be the polarization of a photon. However, the polarization state of quantum particles during propagation thereof, between various devices in a system, is subject to random rotations. These may be due to the birefringence of the various media passed through or indeed to the movement of the transmitter device with respect to the receiver device, such as the movement of a satellite (transmitter or receiver) with respect to a ground station in the case of communications one leg of which is through outer space.

To avoid such random rotations of polarization state, some known quantum systems use only free-space propagation in which the polarization of photons is stable, during propagation thereof through a transmission channel (or communication channel). However, in some applications, it is necessary to use guided optics transmission as a transmission channel, for example in the case of propagation through a ground network or on board a satellite, in order to relax constraints on the construction of the payload.

To compensate for (or correct) random rotations of polarization state, some known systems use, at the start of the quantum protocol implementation, a single polarization reference that makes it possible to initially estimate the polarization rotations induced during propagation and to align the polarization of the transmitted photons with the reception-end measurement bases. However, this single reference does not make it possible to correct new polarization rotations after the initial estimation phase. As an alternative, other existing systems instead use periodic generation of reference signals in the encoding bases using the source of quantum signals, the reference signals being entangled and therefore time-multiplexed with the qubits, this reducing the bandwidth of the system available for payload.

There is thus a need for an improved quantum communication system capable of correcting, in real time, rotations of polarization states of qubits.

### SUMMARY OF THE INVENTION

To this end, the invention proposes a receiver configured to receive a multiplexed optical signal and an optical signal transmitted independently through a transmission channel, the multiplexed optical signal comprising a first quantum signal, the optical signal comprising a second quantum signal, the multiplexed optical signal furthermore comprising at least one polarization state control signal, the receiver comprising a processing chain associated with a polarization base composed of at least one polarization state and designed to determine the polarization state of the at least one polarization state control signal and to modify the polarization of the multiplexed optical signal so as to align the determined polarization state with respect to one of the at least one polarization state of the associated base, the receiver furthermore comprising a correlation module designed to carry out a correlation measurement between the first quantum signal originating from the polarization-modified multiplexed optical signal and the second quantum signal, the correlation module being associated with the polarization base, the correlation module furthermore being designed to generate at least one information signal based on the correlation measurement, the information signal comprising information regarding the entanglement of the polarization states of the first and second quantum signals.

In some embodiments, the processing chain may comprise a control signal detection module and an analysis device, the control signal detection module being configured to demultiplex the at least one control signal and the first quantum signal from the multiplexed optical signal, the detection module furthermore being configured to convey the demultiplexed control signal to the polarization analysis device, the analysis device comprising at least one detection unit designed to detect the control signal according to one of the at least one polarization state of the associated base.

According to some aspects, the detection module may furthermore comprise a processor configured to analyze the determined polarization state and to generate a servo signal applied to a polarization correction module for correcting the polarization of the multiplexed optical signal.

In some embodiments, the receiver may be formed from polarization-maintaining fibers and/or single-mode optical fibers.

The present invention additionally proposes a transmitter configured to transmit optical signals, comprising:
a signal generator configured to generate a first quantum signal, a second quantum signal and a polarization state control signal, the first quantum signal and the second quantum signal being quantum signals entangled with one another,
a signal integrator configured to generate a multiplexed optical signal, the multiplexed signal comprising the first control signal and the first quantum signal.

The transmitter is configured to transmit the multiplexed optical signal and an optical signal comprising the second quantum signal through a transmission channel.

The embodiments of the invention thus provide a quantum communication system comprising a plurality of transmitters, and at least one receiver.

In some embodiments, the plurality of transmitters may comprise at least a first transmitter and a second transmitter, and the system may furthermore comprise a plurality of auxiliary receivers comprising a first auxiliary receiver configured to receive an optical signal comprising a quantum signal transmitted by the first transmitter, and a second auxiliary receiver configured to receive an optical signal comprising a quantum signal transmitted by the second transmitter, each auxiliary receiver being associated with a measurement polarization base composed of at least one polarization state and designed to measure the associated quantum signal according to at least one of the at least one polarization state of the associated measurement polarization base. Each auxiliary receiver may be configured to receive an entanglement information signal comprising information regarding the entanglement of polarization states of quantum signals transmitted by the at least one receiver, each auxiliary receiver being configured to determine a shared quantum encryption key based on the measurement of the associated quantum signal and the information regarding the entanglement of polarization states of quantum signals.

According to some aspects, for one or both auxiliary receivers, the optical signal received by the auxiliary receiver may be a multiplexed optical signal furthermore comprising a polarization state control signal, the one or more auxiliary receivers comprising a processing chain associated with the measurement polarization base and designed to determine the polarization state of the polarization state control signal and to modify the polarization of the multiplexed optical signal so as to align the determined polarization state with respect to one of at least one polarization state of the associated measurement polarization base.

In some embodiments, the multiplexed signals may be frequency-multiplexed signals.

Advantageously, the absolute value of the wavelength difference between the quantum wavelength of a quantum signal and the reference wavelength of a control signal may be greater than or equal to a minimum wavelength difference value.

The invention also proposes a method for determining at least one information signal in response to the receipt of a multiplexed optical signal and of an optical signal that are transmitted independently through a transmission channel, the multiplexed optical signal comprising a first quantum signal, the optical signal comprising a second quantum signal, the multiplexed optical signal furthermore comprising at least one polarization state control signal, the method comprising a processing phase, associated with a polarization base composed of at least one polarization state, for determining the polarization state of the at least one polarization state control signal and for modifying the polarization of the multiplexed optical signal so as to align the determined polarization state with respect to one of the at least one polarization state of the associated base. The method furthermore comprises a correlation step comprising measuring a correlation between the first quantum signal originating from the polarization-modified multiplexed optical signal and the second quantum signal, the correlation measurement being associated with the polarization base, the correlation step furthermore comprising generating the at least one information signal based on the correlation measurement, the information signal comprising information regarding the entanglement of the polarization states of the first and second quantum signals.

The embodiments of the invention thus make it possible to correct the polarization rotations of qubits transmitted between transmitters and receivers of entangled quantum signals, in order notably to establish a quantum key between two remote receivers.

In particular, the embodiments of the invention provide transmitters of optical signals, associated with pairs of entangled quantum particles, making it possible to robustly integrate one or more polarization state reference signals of these quantum particles.

Such references may be generated at any power, independently of the generation of the qubits, to form an effective solution that is accessible in terms of hardware complexity. A guided optics transmitter, according to the embodiments of the invention, advantageously has small bulk and weight, and an optimized footprint and robustness. Moreover, frequency multiplexing such references with the qubits makes it possible to maintain a high bandwidth for transmission of payload information (that is to say qubits).

The one or more receivers according to the embodiments of the invention make it possible to correct, in real time, polarization rotations undergone by the qubits before detection. Such receivers make it possible notably to analyze the qubits and the reference signals independently, in order to best align the polarization of the qubits with measurement bases of the receiver.

### BRIEF DESCRIPTION OF THE DRAWINGS

Other features, details and advantages of the invention will become apparent on reading the description provided with reference to the appended drawings, which are given by way of example.

FIG. 1 is a diagram showing a quantum communication system, according to some embodiments of the invention.

FIG. 2 is a diagram showing a quantum communication system, according to some embodiments of the invention.

FIG. 3 is a diagram showing a transmitter of a quantum communication system, according to some embodiments of the invention.

FIG. 4 is a diagram showing a transmitter of a quantum communication system, according to some embodiments of the invention.

FIG. 5 is a diagram showing a signal generator of a transmitter of a quantum communication system, according to some embodiments of the invention.

FIG. 6 is a diagram showing an intermediate receiver of a quantum communication system, according to some embodiments of the invention.

FIG. 7 is a diagram showing an intermediate receiver of a quantum communication system, according to some embodiments of the invention.

FIG. 8 is a diagram showing a processing chain of an intermediate receiver of a quantum communication system, according to some embodiments of the invention.

FIG. 9 is a diagram showing a detection module for detecting a control signal of an intermediate receiver of a quantum communication system, according to some embodiments of the invention.

FIG. 10 is a diagram showing a detection module for detecting a control signal of an intermediate receiver of a quantum communication system, according to some embodiments of the invention.

FIG. 11 is a diagram showing an end receiver of a quantum communication system, according to some embodiments of the invention.

FIG. 12 is a diagram showing a quantum photon analysis module of an end receiver of a quantum communication system, according to some embodiments of the invention.

FIG. 13 is a flowchart showing a method for transmitting optical signals, implemented by a transmitter of a quantum communication system, according to some embodiments of the invention.

FIG. 14 is a flowchart showing a method for the intermediate reception of optical signals, implemented by a receiver of a quantum communication system, according to some embodiments of the invention.

FIG. 15 is a flowchart showing a method for the final reception of optical signals, implemented by a receiver of a quantum communication system, according to some embodiments of the invention.

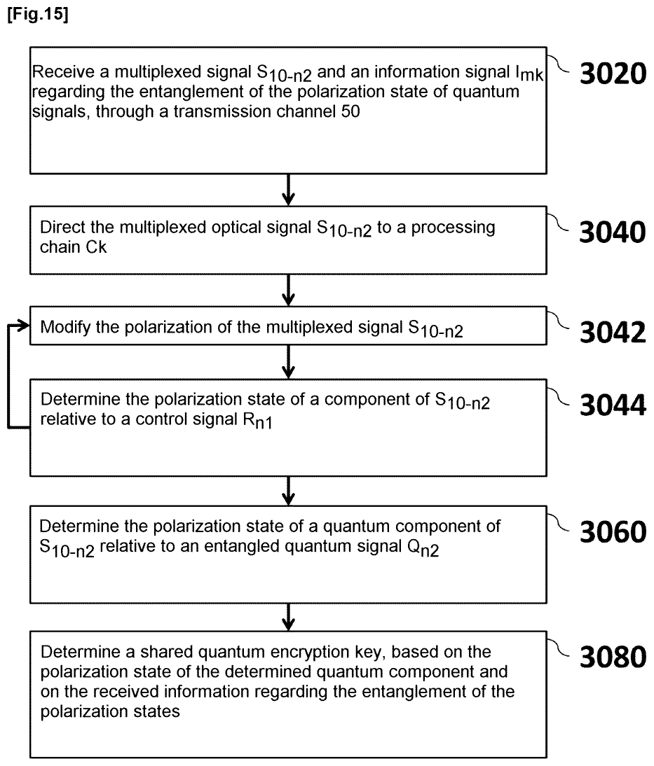

Identical references have been used in the figures to denote identical or similar elements. For the sake of clarity, the elements shown are not to scale.

### DETAILED DESCRIPTION

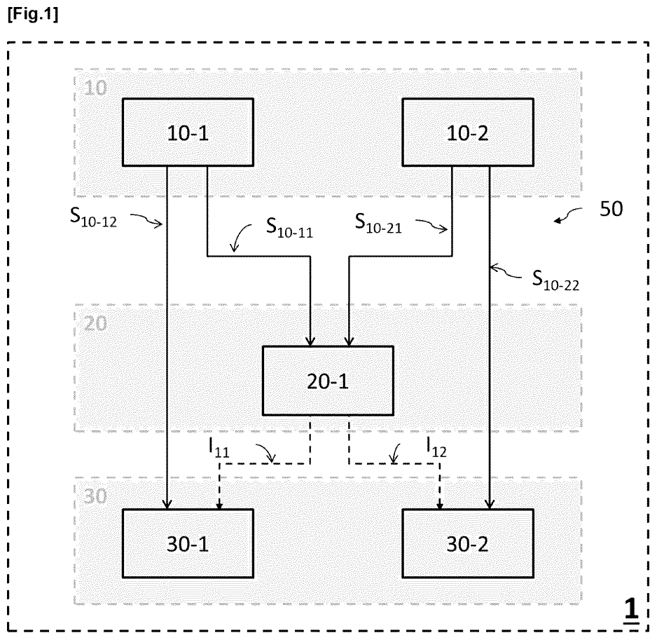

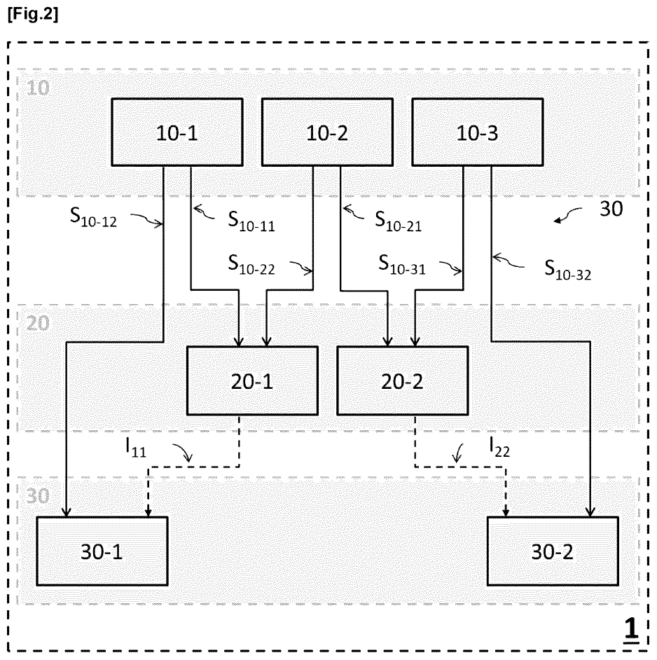

FIGS. 1 and 2 schematically show a quantum communication system 1 comprising a first set of devices 10, a second set of devices 20 and a third set of devices 30, able to communicate with one another, according to some embodiments of the invention.

The first set of devices 10 of the system 1 comprises a plurality of transmitter devices 10-n. The index ‘n’ is associated with the nth transmitter device of the system 1 and is an integer between 1 and N, the value of N being greater than or equal to 2.

The second set of devices 20 of the system 1 comprises one or more receiver devices 20-m, also called ‘intermediate receivers’. The index ‘m’ is associated with the mth receiver device of the system 1 and is an integer between 1 and M, the value of M being greater than or equal to 1.

The third set of devices 30 of the system 1 comprises two receiver devices, also called ‘end receivers’, denoted 30-1 and 30-2 (or more generally 30-k, the index ‘k’ being an integer equal to 1 or 2).

The quantum communication system 1 may be used in various applications. For example and non-limitingly, the quantum communication system 1 may be used in the space sector and comprise a transmitter 10-n and/or a receiver (20-m and/or 30-k) installed on board a satellite. In such an exemplary application of the invention to the space sector, the system 1 may also comprise a transmitter 10-n and/or a receiver (20-m and/or 30-k) on the ground, which may be housed on board one or more terrestrial devices. The system 1 may also be used in avionics applications, at least one of the transmitter devices 10-n and/or receiver devices (20-m and/or 30-k) then being an avionics device. The system 1 may also be used in fiber-optic network applications, in which at least one of the transmitter devices 10-n and/or one receiver (20-m and/or 30-k) is a fiber-optic device integrated in a ground network.

A device of the system 1 may be fixed or moving in relation to another device with which it communicates.

By way of non-limiting example, some devices of the quantum communication system 1 may be quantum computers or quantum sensor arrays.

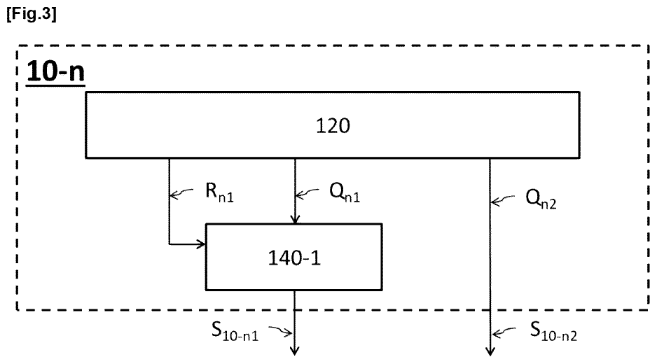

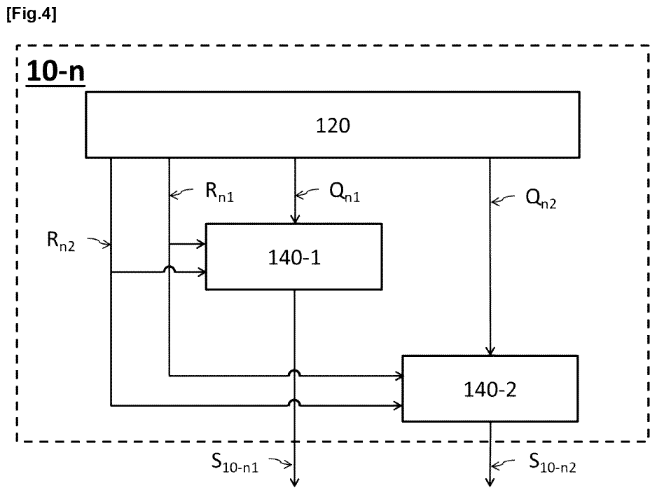

A transmitter 10-n comprises a signal generator 120 (also called ‘signal generation module’) and at least one signal integrator (also called ‘signal integration module’), as shown in FIGS. 3 and 4, which illustrate some embodiments of the invention.

As used here, an ‘optical signal’ (also simply called a “signal”) results from one or more pulses of coherent light generated by an optical source, such as a laser beam for example. A laser beam may notably be characterized by its pulse rate f and by a laser pulse (that is to say the signal) defined by its frequency ω, its intensity I, its polarization P and its phase. The ‘frequency ω’ of the laser beam designates the ‘optical frequency of the laser pulse multiplied by 21’ and is defined as a function of the wavelength of the beam λ, such that

$$λ \times \frac{ω}{2 π} = c ,$$

c designating the speed of light.

A transmitter 10-n of the first set of devices 10 of the system 1 is configured to generate and transmit, through a transmission channel, generally denoted 50, two distinct transmission optical signals, denoted S₁₀₋ₙ₁ and S₁₀₋ₙ₂ (also called ‘first transmission optical signal’ and ‘second transmission optical signal’, respectively).

The transmission channel 50 may for example be a free space or a fiber-optic (or guided optics) device for transporting information, for example using fiber-optic elements for the purpose of communication, depending on the field of application of the invention.

A transmission channel 50 connects a transmitter and a given receiver.

For example, a transmission channel 50_{E-R1} connects a transmitter E to a first receiver R1 for the transmission of a first signal.

A transmission channel 50_{E-R2} may connect this same transmitter E to a second receiver R2 for the transmission of a second signal (independently of the first signal emitted by transmitter E).

Similarly, a given receiver R can be connected to a first transmitter E1 by a transmission channel 50_{E1-R} to receive a first signal, while it is connected to a transmission channel 50_{E2-R} to receive a second signal (independently of the first signal) from a second transmitter E2 distinct from the first transmitter E1. Such examples are illustrated in FIGS. 1 and 2.

Each transmission optical signal delivered by a transmitter 10-n comprises a quantum signal, denoted Qₙ₁ and Qₙ₂, respectively. The two quantum signals Qₙ₁ and Qₙ₂ are entangled with one another, each photon of a quantum signal originating respectively from an entangled photon pair generated by the signal generator 120. The first quantum signal Qₙ₁ is associated with a polarization state, denoted P_{Q-n1}, and the second quantum signal Qₙ₂ is associated with a polarization state, denoted P_{Q-n2}.

As used here, the expression ‘quantum signal’ may refer to a pulsed optical signal having a low number of photons per pulse. Measurement of a quantum signal provides a measurement of detection of a photon (or ‘particle’) depending on a “probability of detection” of this photon.

Moreover, a ‘quantum signal’ may refer to an optical signal comprising at least one photon that is entangled with another photon of another ‘quantum signal’. These two quantum signals are then called ‘entangled quantum signals’. An ‘entangled photon pair’ refers to two photons forming a linked system and exhibiting quantum states dependent on one another regardless of the distance between them. There are correlations between the measurable physical properties (notably between their polarization state) of these distinct particles. The entanglement of a pair of photons results from the fact that these photons, respectively contained in a specific quantum signal, are both generated from the same pump photon. The entangled quantum signals may be pulsed or continuous optical signals.

In some embodiments, the polarization states P_{Q-n1} and P_{Q-n2} of the first and second quantum signal Qₙ₁ and Qₙ₂, respectively, may be identical (that is to say correlated) and/or mutually orthogonal (that is to say anticorrelated). Advantageously, the polarization states P_{Q-n1} and P_{Q-n2} of the entangled quantum signals are not individual polarization states that are well defined when the signals are generated, and may be defined only during an entanglement measurement.

The first transmission optical signal S₁₀₋ₙ₁ delivered by the transmitter 10-n is a multiplexed optical signal (also called ‘multiplexed optical signal’ or ‘multiplexed communication signal’) comprising the first quantum signal Qₙ₁ and a first integrated optical polarization control signal, denoted Rₙ₁. Such a signal is also called ‘first control signal’ or ‘first reference signal’.

In some embodiments, the polarization state of the first control signal Rₙ₁ may be defined in a polarization base B_{Q-n1} (also called ‘first control polarization base’). For example and non-limitingly, the polarization base B_{Q-n1} may be the H/V polarization base comprising an H-type, that is to say “horizontal”, linear polarization state, and a V-type, that is to say “vertical”, linear polarization state. In other embodiments, the polarization base B_{Q-n1} may be the D/A polarization base comprising a D-type, that is to say “diagonal”, linear polarization state, and an A-type, that is to say “anti-diagonal”, linear polarization state.

In some embodiments, the first multiplexed optical signal S₁₀₋ₙ₁ delivered by the transmitter 10-n may furthermore comprise a second integrated optical polarization control signal, denoted Rₙ₂. Such a signal is also called ‘second control signal’ or ‘second reference signal’. Advantageously, the polarization state of the second control signal Rₙ₂ may be defined in a polarization base B_{Q-n2} (also called ‘second control polarization base’). In particular, the polarization base B_{Q-n2} may be a polarization base that is not orthogonal to the polarization base B_{Q-n1} of the first control signal Rₙ₁.

In some embodiments, the second transmission optical signal S₁₀₋ₙ₂ delivered by the transmitter 10-n may also be a multiplexed optical signal comprising, in addition to the second quantum signal Qₙ₂, the first control signal Rₙ₁ and/or the second control signal Rₙ₂.

An intermediate receiver 20-m of the second set of devices 20 of the system 1 is configured to receive, from the transmission channel 50, firstly a multiplexed optical signal, S₁₀₋ₙ (that is to say a signal S₁₀₋ₙ₁ or S₁₀₋ₙ₂), transmitted by a first transmitter 10-n of the first set of devices 10, and secondly a transmission optical signal, S₁₀₋ₕ (corresponding to a signal S₁₀₋ₕ₁ or S₁₀₋ₕ₂) transmitted by a second transmitter, denoted 10-h, of the first set of devices 10 and different from the first transmitter 10-n, the index ‘h’ being an integer between 1 and N and other than the index ‘n’. Thus, as illustrated in FIGS. 1 and 2, the intermediate receiver 20-1, for example, is configured to receive firstly the first transmission optical signal transmitted by the first transmitter 10-1, and secondly a transmission optical signal transmitted by the second transmitter 10-2. The first transmission optical signal received by the intermediate receiver 20-1 is the first transmission optical signal S₁₀₋₁₁ transmitted by the first transmitter 10-1 corresponding to a multiplexed optical signal comprising a quantum signal Qₙ (or Qₙ₁) and at least one first control signal Rₙ₁. Furthermore, the transmission optical signal transmitted by the second transmitter 10-2 may be either the first transmission optical signal S₁₀₋₂₁ corresponding to a multiplexed optical signal or the second transmission optical signal S₁₀₋₂₂ also corresponding to a multiplexed optical signal, or comprising only a quantum signal Qₕ (or Q₂₂, as in the example illustrated in FIGS. 1 and 2).

The intermediate receiver 20-m is then configured to estimate the received first control signal Rₙ₁, via the transmission optical signal transmitted by the first transmitter 10-n, thereby supplying an estimated first control signal, denoted Rₘₙ₁.

In embodiments in which the multiplexed optical signal S₁₀₋ₙ received by the intermediate receiver 20-m, transmitted by the first transmitter 10-n, comprises a second control signal Rₙ₂, the intermediate receiver 20-m may furthermore be configured to estimate the received second control signal Rₙ₂, transmitted by the first transmitter 10-n, thereby supplying an estimated second control signal, denoted Rₘₙ₂.

In some embodiments in which the transmission optical signal S₁₀₋ₕ transmitted by the second transmitter 10-h and received by the intermediate receiver 20-m is a multiplexed optical signal comprising a first control signal Rₕ₁ and/or a second control signal Rₕ₂, the intermediate receiver 20-m may furthermore be configured to estimate the received first and/or second control signal Rₕ₁ and/or Rₕ₂, transmitted by the second transmitter 10-h, thereby supplying an estimated third and/or fourth control signal, denoted Rₘₕ₁ and Rₘₕ₂, respectively.

Moreover, the intermediate receiver 20-m is configured to carry out a correlated measurement of quantum signals, relating to the quantum signal Qₙ of the received multiplexed optical signal S₁₀₋ₙ, transmitted by the first transmitter 10-n, and to the quantum signal Qₕ (that is to say Qₕ₁ or Qₕ₂) of the received transmission optical signal S₁₀₋ₕ (that is to say S₁₀₋ₕ₁ or S₁₀₋ₕ₂, respectively), transmitted by the second transmitter 10-h. The correlated measurement of quantum signals is furthermore carried out based on the estimated first control signal Rₘₙ₁ estimated by the intermediate receiver 20-m.

In some embodiments, the correlated measurement of quantum signals may also be carried out based on the estimated second control signal Rₘₙ₂, on the estimated third control signal Rₘₕ₁ and/or on the estimated fourth control signal Rₘₕ₂.

Each of the quantum particles originating from the two quantum signals, that is to say Qₙ and Qₕ, received separately by the intermediate receiver 20-m, is associated with an independently generated entangled photon pair. Moreover, the particles of the first quantum signal Qₙ₁ of the multiplexed optical signal S₁₀₋ₙ₁ transmitted by the first transmitter 10-n to the receiver 20-m belong to an entangled pair associated with the particles of the second quantum signal Qₙ₂ of the transmission optical signal S₁₀₋ₙ₂ transmitted by the first transmitter 10-n. Similarly, the particles of the quantum signal Qₕ, for example and non-limitingly of the first quantum signal Qₕ₁, of the transmission optical signal S₁₀₋ₕ₁ transmitted by the second transmitter 10-h to the receiver 20-m belong to an entangled pair associated with the particles of the second quantum signal Qₕ₂ of the transmission optical signal S₁₀₋₁₂ transmitted by the second transmitter 10-h.

Advantageously, the correlated measurement of quantum signals carried out by the intermediate receiver 20-m may be a Bell measurement, projecting these received quantum particles, Qₙ and Qₕ, into a polarization-entangled Bell state. Such a projection induces an entanglement (or a correlation) called ‘resultant entanglement’ between these received particles. This resultant entanglement consequently induces an entanglement called ‘teleported entanglement’ (or ‘induced entanglement’ or ‘consequent entanglement’) between the quantum particles entangled with the particles Qₙ and Qₕ received by the receiver 20-m, that is to say respectively between:
the particles of the second quantum signal Qₙ₂ of the transmission optical signal S₁₀₋ₙ₂ transmitted by the first transmitter 10-n (that is to say not received by the receiver 20-m), and the particles of the second quantum signal Qₕ₂ of the transmission optical signal S₁₀₋₁₂ transmitted by the second transmitter 10-h (that is to say not received by the receiver 20-m), if the intermediate receiver 20-m is configured to receive the multiplexed optical signal S₁₀₋ₕ₁, or
the particles of the second quantum signal Qₙ₂ of the transmission optical signal S₁₀₋ₙ₂ transmitted by the first transmitter 10-n (that is to say not received by the receiver 20-m), and the particles of the first quantum signal Qₕ₁ of the multiplexed optical signal S₁₀₋ₕ₁ transmitted by the second transmitter 10-h (that is to say not received by the receiver 20-m), if the intermediate receiver 20-m is configured to receive the transmission optical signal S₁₀₋ₕ₂.

In some embodiments, the two end receivers 30-1 and 30-2 (also called “additional receivers” or “auxiliary receivers”) of the third set of devices 30 of the system 1 may each be configured to receive a distinct transmission optical signal from the transmission channel 50. The two transmission optical signals, each received by an end receiver 30-k, are transmitted independently by two distinct transmitters from the first set of devices 10. These transmission optical signals are thus not received beforehand by any intermediate receiver 20-m of the second set of devices 20.

In some embodiments, the first end receiver 30-1 may then be configured to receive a transmission optical signal S₁₀₋ₙ (and specifically S₁₀₋ₙ₂) transmitted by a transmitter 10-n, whereas the second end receiver 30-2 may be configured to receive a transmission optical signal S₁₀₋ₕ (and specifically S₁₀₋ₕ₂ or S₁₀₋ₕ₁) transmitted by another transmitter 10-h of the first set of devices 10. Each end receiver 30-k may thus be configured to estimate the quantum signal originating from the received transmission optical signal, thereby supplying an estimated received quantum signal, denoted S_{Qk}, respectively (that is to say S_{Q1} for the first end receiver 30-1 or S_{Q2} for the second end receiver 30-2).

For example and non-limitingly, as illustrated in FIGS. 1 and 2, the first end receiver 30-1 may be configured to receive the transmission optical signal S₁₀₋₁₂ (optionally being a multiplexed optical signal) transmitted by the first transmitter 10-1, and thus be configured to determine the estimated received quantum signal S_{Q1} (that is to say estimate the second quantum signal Q12 originating from the signal S₁₀₋₁₂).

In the example illustrated in FIG. 1, the second end receiver 30-2 may be configured to receive the transmission optical signal S₁₀₋₂₂ (optionally being a multiplexed optical signal) transmitted by the second transmitter 10-2, whereas, in the example illustrated in FIG. 2, the second end receiver 30-2 may be configured to receive the transmission optical signal S₁₀₋₃₂ (optionally being a multiplexed optical signal) transmitted by a third transmitter 10-3 of the first set of devices 10. The second end receiver 30-2 may also be configured to determine the estimated received quantum signal S_{Q2} (that is to say estimate the second quantum signal Q22 originating from the signal S₁₀₋₂₂, or Q32 originating from the signal S₁₀₋₃₂ for example).

Moreover, in embodiments in which the second set of devices 20 of the system 1 comprises a single intermediate receiver, which is then denoted 20-1, as shown in FIG. 1, the single receiver 20-1 may furthermore be configured to generate two information signals each comprising the result of the correlated measurement of quantum signals carried out by the single receiver 20-1 (that is to say comprising the result of the projection of the quantum particles received independently in a Bell polarization state). Each information signal, denoted 112 or 122, comprising resultant entanglement information derived from the correlated measurement carried out, may be transmitted to one of two end receivers 30-1 or 30-2, respectively.

Thus, as used herein, the skilled person will readily understand that the expression ‘resultant entanglement information’ refers to ‘correlation information’ between quantum signals coming from the measurement of correlation between these independent optical signals (that is between quantum particles received Qₙ and Qₕ which are not coming from an entangled signal generation operation, unlike for example the quantum signals which are entangled with each other, respectively denoted Qₙ₁ and Qₙ₂, generated by the same transmitter 10-n).

As an alternative, in embodiments in which the second set of devices 20 of the system 1 comprises multiple intermediate receivers, as shown in FIG. 2, a predetermined receiver 20-m from among the second set 20 may be configured to generate a first information signal comprising the result of the correlated measurement of quantum signals, carried out by the predetermined receiver 20-m, whereas another receiver, denoted 20-p, also predetermined from among the second set 20, may be configured to generate a second information signal comprising the result of the correlated measurement of quantum signals carried out by the other predetermined receiver 20-p. In this case, the index ‘p’ is an integer between 1 and M, and other than the index ‘m’. The first information signal, denoted for example Iₘₖ, comprises resultant entanglement information derived from the correlated measurement, carried out by the predetermined receiver 20-m, and may be transmitted to one receiver 30-k of the two end receivers, whereas the second information signal, denoted for example I_{pq}, comprises resultant entanglement information derived from the correlated measurement, carried out by the predetermined receiver 20-p, and may be transmitted to the other receiver 30-q of the two end receivers of the system 1. In this embodiment, the index ‘q’ is an integer equal to 1 or 2, and other than the index ‘k’.

The information signals, generally denoted Iₘₖ, may be transmitted by an intermediate receiver to an end receiver of the system 1, through the transmission channel 50. Moreover, a resultant entanglement information value to be included in an information signal to be transmitted may correspond, for example and non-limitingly, to an entanglement value equal to 1, associated with received photons of quantum signals Qₙ and Qₕ having mutually identical (that is to say correlated) polarization states, or alternatively to an entanglement value equal to 0, associated with received photons having mutually different (that is to say anti-correlated) polarization states.

Each end receiver 30-k (30-1 and 30-2) of the third set of devices 30 of the system 1 may thus be configured to receive a single entanglement information signal Iₘₖ transmitted by an intermediate receiver 20-m of the second set of devices 20, and to determine (that is to say deduce therefrom) the one or more associated items of resultant entanglement information.

According to one aspect of the invention, the first end receiver 30-1 and the second end receiver 30-2 of the third set of devices 30 of the system 1 may be configured to determine (that is to say establish) a quantum encryption key using the received quantum signal S_{Q1} estimated by the first end receiver 30-1 and the received quantum signal S_{Q2} estimated by the second end receiver 30-2. In particular, such a quantum key distribution is also carried out based on the entanglement information signals Iₘ₁ and Iₘ₂ (or for example Iₘ₁ and I_{q2}) received by the end receivers 30-k, and therefore based on the associated resultant entanglement information, the two estimated received quantum signals S_{Qk} being associated respectively with a teleported entanglement generated by one or more resultant entanglements originating from one or more intermediate receivers 20-m. The system 1 may thus be a quantum encryption key distribution system based on quantum “teleportation”. In other words, the system 1 may be configured to perform quantum key distribution using one or more quantum repeaters, corresponding respectively to one or more intermediate receivers configured to “repeat” resultant entanglement information initially derived from multiple independently generated entangled photon pair transmitters. The quantum key distribution may notably be implemented within a space or terrestrial communication service with the aim of securing some or all of the communications exchanged between the end receivers, for example.

FIGS. 3 and 4 schematically show a transmitter 10-n of the first set of devices 10, configured to form at least one multiplexed optical signal, according to some embodiments of the invention.

The multiplexed optical signal transmitted by the transmitter 10-n is generated via a signal integrator of the transmitter 10-n from a quantum signal and at least one control signal, delivered by a signal generator 120.

In some embodiments, the transmitter 10-n may comprise a single signal integrator, denoted 140-1 (or 140), configured to generate the multiplexed optical signal S₁₀₋ₙ₁.

Advantageously, the transmitter 10-n may comprise two signal integration modules, denoted 140-1 and 140-2, each configured to generate a multiplexed optical signal. The first integrator 140-1 may be configured to generate the first multiplexed optical signal S₁₀₋ₙ₁ and the second integrator 140-2 may be configured to generate the second multiplexed optical signal S₁₀₋ₙ₂.

The single (or the first) signal integrator 140-1 is configured to generate the (first) multiplexed optical signal S₁₀₋ₙ₁ from the first quantum signal Qₙ₁ and (at least) the control signal Rₙ₁, as shown in FIGS. 3 and 4.

In some embodiments in which a transmitter 10-n is configured to produce the two control signals Rₙ₁ and Rₙ₂, as shown in FIG. 4, the first (or the single) signal integrator 140-1 may be configured to generate the (first) multiplexed optical signal S₁₀₋ₙ₁, also from the second control signal Rₙ₂.

In some embodiments, the second signal integrator 140-2, shown in FIG. 4, may be configured to generate the second multiplexed optical signal S₁₀₋ₙ₂ from the second quantum signal Qₙ₂ and from the first control signal Rₙ₁ and/or from the second control signal Rₙ₂.

Thus, in other words, an integration module of a transmitter 10-n, configured to generate a multiplexed optical signal, is designed to optically multiplex (or optically combine), on the same optical path, a quantum signal with one or more control signals.

In embodiments in which a transmitter 10-n is a guided optics (or fully optical) device, that is to say comprising optical signal transmission channels consisting of optical fibers and/or what are known as integrated waveguides, typically used in integrated photonics, one or more transmission means of the transmitter may consist of polarization-maintaining fibers (PMF) and/or single-mode optical fibers (SMF).

In some embodiments, a multiplexed optical signal generated by a transmitter 10-n of the first set of devices 10 may be frequency-multiplexed. In this case, the signal generator 120 of the transmitter may be configured to generate the entangled quantum signals, Qₙ₁ and Qₙ₂, with a wavelength denoted λ_{Q} (or with respective wavelengths λ_{Qn1} and λ_{Qn2}, and also called ‘quantum wavelengths’), and at least the first control signal Rn with a control wavelength (or ‘reference wavelength’ denoted λ_{Rn1}), the one or more quantum wavelengths being distinct from the control wavelength.

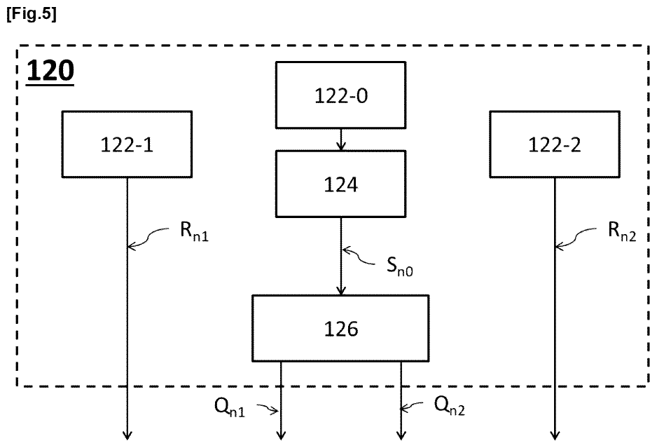

In some embodiments, the signal generator 120 may furthermore be configured to generate the second control signal Rₙ₂ with a control wavelength denoted λ_{Rn2}, all three of the wavelengths λ_{Q}, λ_{Rn1} and λ_{Rn2} being distinct from one another. FIG. 5 schematically shows such a signal generator 120, according to some embodiments of the invention.

Advantageously, the signal generator 120 may comprise a first laser source 122-0 emitting a laser beam (or ‘pump laser’) with a wavelength λₚᵤₘₚ. The laser emission pump wavelength λₚᵤₘₚ may be located in the visible or the infrared. For example and non-limitingly, the first laser source 122-0 may be a DFB (distributed feedback) laser diode using a Bragg grating allowing the emission wavelength λₚᵤₘₚ to be chosen. The chosen emission wavelength λₚᵤₘₚ of the laser diode may be equal to 780 nm, for example. Such a laser diode notably emits a continuous-wave laser beam. As an alternative, the first laser source 122-0 may be a pulsed laser unit, that is to say a gain-switched laser unit.

The signal generator 120 may also comprise one or two other additional laser sources, denoted 122-1 and 122-2, as shown in FIG. 5, configured to respectively emit a laser beam with a wavelength λ_{R1} and a laser beam with a wavelength λ_{R2}. The laser emission wavelengths λ_{R1} and λ_{R2} may be located in the visible or the infrared. For example and non-limitingly, the one or more additional laser sources 122-1 and 122-2 may be DFB laser diodes or gain-switched laser units.

According to some embodiments, the signal generation module 120 may furthermore comprise one or more intensity modulation units 124 configured to modulate the intensity of the laser pulses generated at the output of the first laser source 122-0 and form quantum pulses.

An intensity modulation unit 124 may also be configured to modulate the rate of the laser pulses, which is of the order of a few kilohertz to a few tens of gigahertz, for example, and/or the temporal width of the laser pulses, which is for example up to a few nanoseconds.

As shown in FIG. 5, the signal generation module 120 may furthermore comprise an entanglement unit 126, configured to receive a single initial optical signal, denoted Sₙ₀, and to deliver the two entangled quantum signals, corresponding to the first and second quantum signal Qₙ₁ and Qₙ₂, comprising entangled photon pairs. Such an entanglement unit 126 may advantageously be arranged at the output of an intensity modulation unit 124.

For example and non-limitingly, the entanglement unit 126 may be implemented in the form of a Sagnac loop, in which the passage of the initial optical signal Sno through a non-linear crystal (or a microresonator), in particular in two distinct directions, generates a pair of polarization-entangled photons. Such a non-linear crystal may be a PPLN (periodically poled lithium niobate) crystal.

Advantageously, the quantum wavelengths λ_{Qn1} and λ_{Qn2} (or λ_{Q}) of the entangled quantum signals may be determined as a function of the pump wavelength pump of the initial optical signal Sₙ₀. In particular, since the conservation of energy during the generation of an entangled photon pair is respected, the sum of the frequencies of the entangled photons is equal to the frequency of the initial pump photon. By way of illustration, for a wavelength λₚᵤₘₚ equal to 780 nm, the quantum wavelengths may be equal to approximately 1560 nm, in order to respect the conservation of energy.

In some embodiments, the frequency difference between a quantum wavelength λ_{Q} and a reference wavelength (λ_{R1} and/or λ_{R2}) may be greater than or equal to a first minimum wavelength difference value δλ, according to the following inequality (01):

$$\vert {λ}_{Q} - {λ}_{R 1 / R 2} \vert \geq δ λ \qquad ( 01 )$$

Moreover, in embodiments in which the generator 120 comprises two distinct laser sources 122-1 and 122-2, the frequency difference between the reference wavelengths (λ_{R1} and/or λ_{R2}) of each of the control signals Rₙ₁ and Rₙ₂ may be greater than or equal to a second minimum wavelength difference value δλ′, according to the following inequality (02):

$$\vert {λ}_{R 1} - {λ}_{R 2} \vert \geq {δλ}^{′} \qquad ( 02 )$$

Advantageously, the first minimum wavelength difference value δλ and the second minimum wavelength difference value δλ′ may be predefined and equal, for example and non-limitingly, to 1.6 nm and 0.8 nm, respectively.

In embodiments in which the transmitter 10-n is a device comprising free-space signal transmission means, an entanglement unit 126 of the signal generator 120 may comprise one or more dichroic filters that make it possible notably to direct the initial optical signal Sno to the Sagnac loop and/or to separate (that is to say filter), on two distinct optical paths, the two photons of each formed entangled photon pair so as to deliver the two entangled quantum signals Qₙ₁ and Qₙ₂.

In embodiments in which a multiplexed signal generated by the transmitter 10-n is frequency-multiplexed (that is to say the quantum wavelength λ_{Q} and reference wavelengths λ_{R1} and/or λ_{R2} are distinct from one another), a signal integrator (140-1 and/or 140-2) of the transmitter 10-n may comprise one or two wavelength division multiplexing (WDM) units, each unit being designed to combine a quantum signal under consideration and one of the control signals (Rₙ₁ or Rₙ₂) on the same optical path into a resultant signal.

In some embodiments, such a signal integrator may alternatively comprise one or two dichroic filters, each filter being designed to combine a quantum signal under consideration and one of the control signals (Rₙ₁ or Rₙ₂) on the same optical path into a resultant signal.

In some embodiments, a multiplexed optical signal generated by a transmitter 10-n of the first set of devices 10 may be time-multiplexed. In this case, such a multiplexed signal may be a signal comprising a set of two or three temporally distinct pulses, the set being repeated with a period T, the distinct pulses corresponding respectively to an entangled quantum signal, Qₙ₁ or Qₙ₂, a first control signal Rₙ₁ and/or a second control signal Rₙ₂.

Advantageously, the entangled quantum signals and the control signals generated by the signal generator 120 may be pulsed signals characterized by a period T identical to the period of the multiplexed signal delivered by the transmitter 10-n.

In some embodiments, the signal generator 120 may be configured to generate the entangled particle pair (Qₙ₁ and Qₙ₂) and the control signals Rₙ₁ and Rₙ₂ with a predefined time shift between each pulse. As an alternative (or in addition), a signal integrator (140-1 and/or 140-2) may be configured to apply a predefined time offset between a quantum signal and a control signal so as to obtain time-multiplexed signal pulses.

It should be noted that, in embodiments involving time division multiplexing, the entangled particles (Qₙ₁ and Qₙ₂) of the same pair are not time-shifted.

The resultant time difference between each of the successive distinct pulses in a multiplexed signal may thus be strictly less than the repetition period T of the resultant signal (or quantum signal), according to the following inequalities (03) and (04):

$$\vert {t}_{Q} - {t}_{R 1 / R 2} \vert < T \qquad ( 03 )$$

$$\vert {t}_{R 1} - {t}_{R 2} \vert < T \qquad ( 04 )$$

In these embodiments in which the multiplexed signal generated by a transmitter 10-n is time-multiplexed, the quantum wavelength λ_{Q} and reference wavelengths (λ_{R1} and/or λ_{R2}) may be equal to one another.

In this case, the first laser source 122-0 and the one or more additional laser sources 122-1 and 122-2 may for example correspond to a single laser source 122-0, and the signal generator 120 may furthermore comprise a beam-splitting unit (not shown in the figures) configured to supply one or two signal components associated with the control signals Rₙ₁ and Rₙ₂, and also another signal component associated with the initial optical signal Sₙ₀. Such a beam-splitting unit may comprise one or more symmetrical or asymmetrical optical couplers, for example polarization-maintaining optical couplers. The beam-splitting unit may furthermore be an optical selector generating a predefined time shift between each signal component delivered.

In some embodiments, the beam-splitting unit of the signal generator 120 may be arranged at the output of the first laser source 122-0, the resultant control signals Rₙ₁ and Rₙ₂ then corresponding to conventional (that is to say non-quantum) light pulse signals. As an alternative, this beam-splitting unit may be arranged at the output of an intensity modulation unit 124, the resulting control signals Rₙ₁ and Rₙ₂ then corresponding to signals with low luminous intensities.

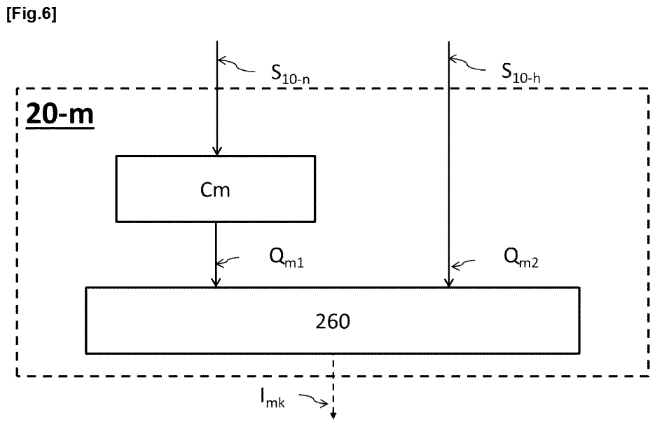

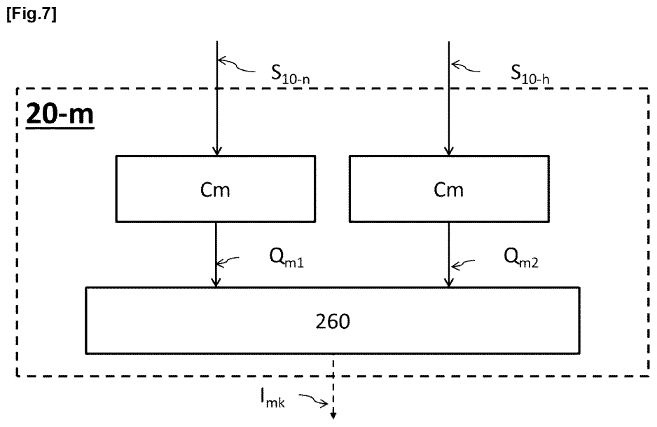

FIGS. 6 and 7 schematically show an intermediate receiver 20-m comprising at least one received multiplexed optical signal processing chain, and a correlation module 260, according to some embodiments.

The correlation module 260 of an intermediate receiver 20-m is configured to carry out a correlated measurement of a received first quantum signal Qₘ₁ originating from a first transmitter 10-n, with a received second quantum signal Qₘ₂ originating from a second transmitter 10-h.

In particular, the correlation module 260 may be implemented in the form of an optical instrument, such as for example an optical interferometer, in order to perform a Bell measurement (corresponding to a Bell measurement module). Such a correlation module 260 comprises notably a plurality of detection units. Each detection unit may be designed to measure one or more quantum signals according to a predefined measurement polarization state, for example, in a polarization base B₂₆₀ (also called ‘measurement polarization base’ and corresponding, for example and non-limitingly, to an H/V base or a D/A base).

A processing chain of an intermediate receiver 20-m, denoted Cm, is configured to receive a multiplexed optical signal and deliver a received quantum signal Qₘ. For example, as shown in FIGS. 6 and 7, a processing chain Cm may be configured to receive the multiplexed optical signal S₁₀₋ₙ (or S₁₀₋ₙ₁) transmitted by a first transmitter 10-n and deliver the received first quantum signal Qₘ₁ associated with the signal Qₙ (or Qₙ₁) transmitted by the first transmitter 10-n via the signal S₁₀₋ₙ.

A processing chain Cm is furthermore designed to determine the polarization state of the one or more control signals originating from the received multiplexed optical signal. For example, the processing chain Cm may be associated with the first control polarization base B_{Q-n1} and be designed to measure, in this base, the polarization state of the first control signal Rₙ₁ transmitted by the first transmitter 10-n via the multiplexed optical signal S₁₀₋ₙ. The processing chain Cm may furthermore be associated with the second control polarization base B_{Q-n2} and be designed to measure, in this second base, the polarization state of the second control signal Rₙ₂ transmitted by the first transmitter 10-n via the multiplexed optical signal S₁₀₋ₙ.

A processing chain Cm is furthermore designed so as to align a determined polarization state with one of the predefined measurement polarization states of the correlation module 260. In some embodiments, the measurement polarization base B₂₆₀ may correspond to the first control polarization base B_{Q-n1}. As an alternative, the measurement polarization base B₂₆₀ may correspond to the second control polarization base B_{Q-n2}. As used here, the expression ‘alignment of a polarization state with a polarization base’ refers to a rotation of the polarization state of the signal so that it corresponds to a specific detection axis of the base as determined by a quantum signal detection equipment.

A processing chain Cm of an intermediate receiver 20-m may thus be designed to rotate the polarization state of all the signals originating from the received multiplexed optical signal, at the input of the processing chain Cm, so as to ensure that the particles of the quantum signal Qₘ at the output of the processing chain Cm are aligned with the measurement polarization base B₂₆₀.

In some embodiments, as shown in FIG. 7, an intermediate receiver 20-m may comprise two processing chains Cm each configured to process either the multiplexed optical signal S₁₀₋ₙ transmitted by the first transmitter 10-n or the multiplexed optical signal S₁₀₋ₕ transmitted by the second transmitter 10-h.

In other embodiments, an intermediate receiver 20-m may comprise a single processing chain Cm configured to process the multiplexed optical signal S₁₀₋ₙ transmitted by the first transmitter 10-n, as shown in FIG. 6. In this case, the transmission optical signal S₁₀₋ₕ transmitted by the second transmitter 10-h is not a multiplexed signal and comprises only a quantum signal Qₕ, corresponding directly to the received second quantum signal Qₘ₂ originating from a second transmitter 10-h.

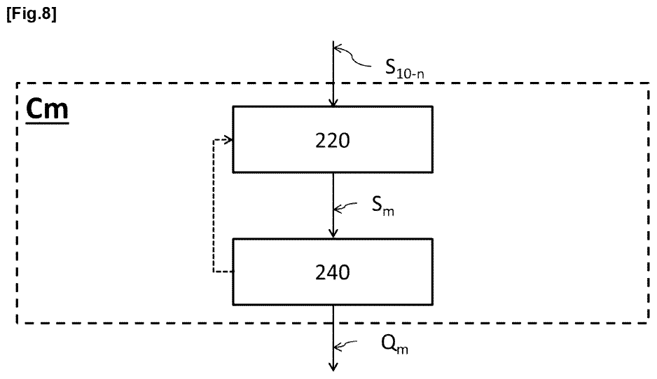

Advantageously, a processing chain Cm may comprise a servo loop between a polarization state correction module 220 and a control signal detection module 240. As shown in FIG. 8, the correction module 220 may be arranged upstream of the detection module 240.

A correction module 220 of an intermediate receiver 20-m may be configured to modify the polarization of a signal passing through it, in response to a setpoint signal. The correction module 220 may therefore be configured to receive a multiplexed optical signal (for example S₁₀₋ₙ, or more precisely S₁₀₋ₙ₁, transmitted by a first transmitter 10-n) and deliver a polarization-modified multiplexed optical signal, denoted Sₘ.

The setpoint signal of the correction module 220 may be an electrical or radiofrequency signal, for example. Advantageously, a correction module 220 may be a fiber-optic polarization controller comprising notably one or more polarization-rotating fibers the one or more stress axes of which (which are designed to rotate the polarization of the signal) are controlled (or adjusted) based on the setpoint signal. For example and non-limitingly, such a controllable stress axis may be implemented in the form of a wound fiber component with an adjustable geometry, or using a piezoelectric element inducing mechanical stresses on a fiber. As an alternative, a correction module 220 may comprise one or more what are referred to as active retarder plates, that is to say whose plate rotation (that is to say rotation of its optical axis) is controlled (or adjusted) based on the setpoint signal. The correction module 220 may be, for example and non-limitingly, a triplet of active retarder plates comprising, in succession, a quarter-wave plate, a half-wave plate and a quarter-wave plate.

In some embodiments, the transmission means of an intermediate receiver 20-m, and in particular of a processing chain Cm, may be single-mode optical fibers SMF, and/or advantageously polarization-maintaining fibers PMF.

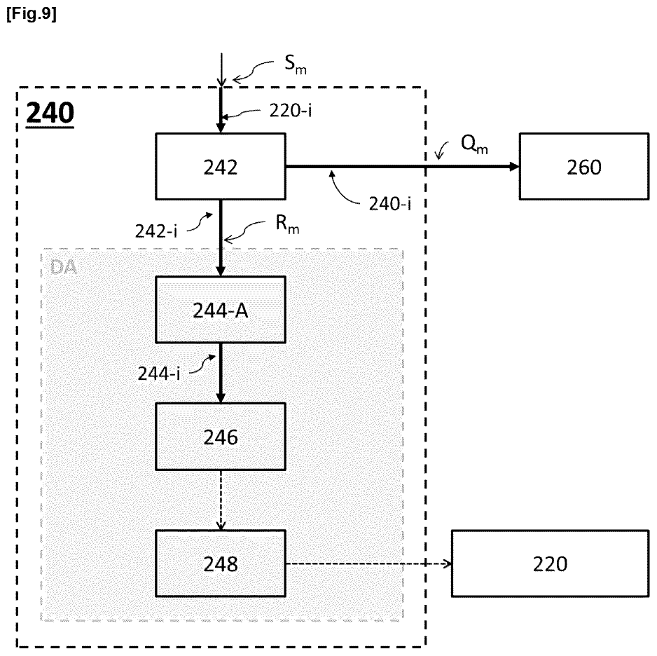

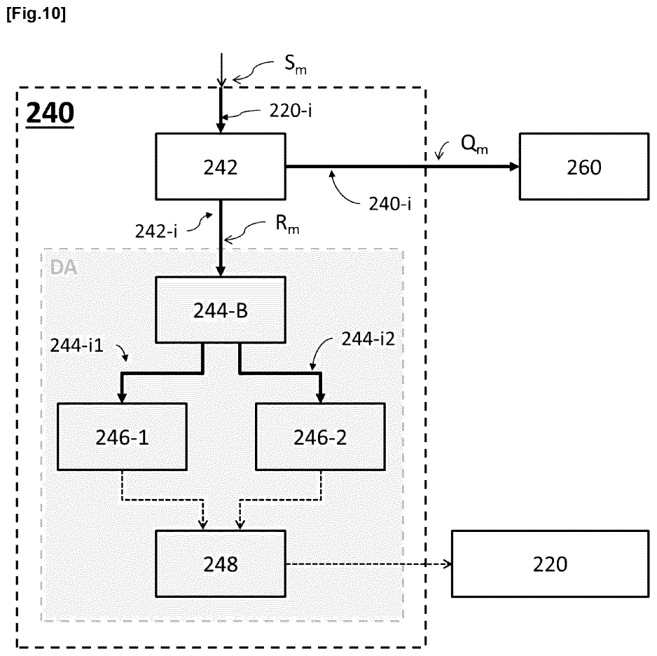

FIGS. 9 and 10 schematically show a detection module 240 of a processing chain Cm comprising a signal demultiplexing unit 242 and an analysis device DA for analyzing the polarization of the control signal, according to some embodiments of the invention.

The signal demultiplexing unit 242 may receive, at input, the polarization-modified multiplexed optical signal Sₘ and may be configured to separate, from this signal, a received quantum signal component Qₘ relating to the quantum signal originating from the received multiplexed signal, and respectively one or two received control signal components Rₘ relating to the one or more control signals originating from the received multiplexed signal. For example, for a received multiplexed optical signal S₁₀₋ₙ transmitted by a first transmitter 10-n and comprising the quantum signal Qₙ (or Qₙ₁) and the control signal Rₙ₁, the demultiplexing unit 242 may be configured to determine the signal quantum component Qₘ relating to the quantum signal Qₙ₁ and the signal control component Rₘ relating to the control signal Rₙ₁.

The demultiplexed quantum component Qₘ of the signal Sₘ at the output of the unit 242 may then be conveyed to the correlation module 260 of the intermediate receiver 20-m, whereas the control component Rₘ may be conveyed to an analysis device DA.

In embodiments in which the received multiplexed optical signal S₁₀₋ₙ comprises the quantum signal Qₙ₁ and the two control signals Rₙ₁ and Rₙ₂, the demultiplexing unit 242 may be configured to separate the quantum component Qₘ relating to the quantum signal Qₙ₁, a first signal control component Rₘ₁ relating to the first control signal Rₙ₁ and a second signal control component Rₘ₂ relating to the second control signal Rₙ₂. In this case, the first control component Rₘ₁ may be conveyed to a first analysis device, whereas the second control component Rₘ₂ may be conveyed to a second analysis device (not shown in the figures). The two analysis devices are configured analogously, each matched to the characteristics of the control component to be processed, that is to say to the control polarization base (B_{Q-n1} and B_{Q-n2}) to be used and, optionally, to the reference wavelength under consideration. The use of two distinct analysis devices makes it possible to achieve a better estimate of the polarization rotations (or distortions) undergone by the multiplexed optical signal S₁₀₋ₙ between transmission and reception on the transmission channel. For example and non-limitingly, the second analysis device may be used to confirm the polarization analysis of the control signal as determined by the first analysis device.

In embodiments involving time division multiplexing, in which the received multiplexed optical signal S₁₀₋ₙ comprises the quantum signal Qₙ₁ and the two control signals Rₙ₁ and Rₙ₂, the demultiplexed first and second signal control components Rₘ₁ and Rₘ₂ may be conveyed to a single analysis device, configured to alternately analyze these components as a function of the time difference between the successive distinct pulses associated with the control signals.

The demultiplexing unit 242 of a detection module 240 may notably comprise one or more demultiplexing elements determined as a function of the type of multiplexing of the signal by the transmitter under consideration, that is to say frequency division and/or time division multiplexing.

In embodiments in which the received multiplexed signal is frequency-multiplexed, the demultiplexing unit 242 may comprise at least one filter configured to separate the quantum component Qₘ from a control component Rₘ. For example and non-limitingly, such a filter may be a band rejection filter such as an FBG (fiber Bragg grating) filter or a filter called “add/drop WDM”. The filter may be chosen based on the predetermined frequency difference between the quantum wavelength λ_{Q} and a reference wavelength (λ_{R1} and/or λ_{R2}), defined for example by equation (01).

In some embodiments, the demultiplexing unit 242 may furthermore comprise a filter configured to separate control components from one another. Such a filter may be chosen based on the predetermined frequency difference between the reference wavelengths λ_{R1} and λ_{R2} of each of the control signals, and defined for example by equation (02).

The transmission means 240-i and 242-i at the output of the demultiplexing unit 242 going to the correlation module 280 and the analysis device DA, respectively, as well as transmission means contained in the unit 242 (not shown in the figures), may be single-mode optical fibers SMF. Advantageously, these transmission means may be polarization-maintaining fibers PMF.

An analysis device DA for analyzing the polarization of the control signal of a processing chain Cm may be configured to detect the control component Rₘ to be processed, according to a predefined polarization base, so as to supply an estimated control signal.

It should be noted that, at the output of a transmitter 10-n, a control signal (Rₙ₁ and/or Rₙ₂) is characterized by its polarization state, which is well defined. During the propagation of a multiplexed signal between the transmitter 10-n and an intermediate receiver 20-m, the polarization state of the control signal under consideration may have undergone random rotations such that the polarization state of the received and detected control component Rₘ relative to the control signal under consideration may be different from the initially defined polarization state.

Thus, the analysis device DA for analyzing the polarization of the control signal may comprise at least one detection unit configured to detect the control signal under consideration, notably according to a predefined polarization, so as to supply the estimate of the received control signal (for example Rₘₙ₁ or Rₘₙ₂, respectively).

In some embodiments, a detection unit of the analysis device DA may be designed to detect conventional light pulse signals. For example and non-limitingly, such a unit may be a photodiode configured to deliver a photocurrent as a function of the measurement of the received control signal component associated with the processing chain Cm.

As an alternative, a detection unit of the analysis device DA may be a single-photon detection unit. Such a unit may consist of a detection surface configured to detect the “presence” of single photons at its detection surface (that is to say via photon/surface interaction). This detection of the presence of single photons is defined in terms of a given quantum detection efficiency. For example and non-limitingly, the single-photon detection unit may be an avalanche photodiode detector (APD) or else a superconducting nanowire single-photon detector (SNSPD). In particular, the single-photon detection unit may comprise an internal amplification mechanism configured to deliver a voltage, when a photon is detected.

In some embodiments, as shown in FIG. 9, the analysis device DA may comprise a polarizer 244-A and a single detection unit 246 for detecting the control component Rₘ associated with the control signal under consideration, for example Rₙ₁ (or Rₙ₂). The polarizer 244-A (also called ‘polarizing filter’) may be designed to transmit, to the detection unit 246, only optical signals defined in a predefined polarization state. The detection unit 246 is thus configured to detect light energy relating to the control component Rₘ defined only according to the polarization state under consideration (that is to say of the predefined polarization base processed by the analysis device DA), and to provide the estimate of the received control signal, for example Rₘₙ₁ (or Rₘₙ₂, respectively). According to this configuration, the value of the control signal detected (or measured) by the detection unit 246 is at a maximum if the polarization state of the received control signal component is equal to the predefined polarization state. Conversely, the detected value of the control signal may be at a minimum if the polarization state of the received control signal component is orthogonal to the predefined polarization state.

Advantageously, the analysis device DA may comprise a polarizing detection unit directly grouping together (that is to say combining) the functionalities of the polarizer 244-A and of the detection unit 246.

In some embodiments, as shown in FIG. 10, the analysis device DA may comprise a polarized-beam splitting unit 244-B, preceded by two distinct detection units 246-1 and 246-2. The polarized-beam splitting unit 244-B (also called ‘polarizing splitter’) may be designed to supply two polarized signal sub-components relating to the control component Rₘ under consideration. Each sub-component may propagate on a transmission means (244-i1 or 244-i2) at the output of the splitting unit 244-B to one of the two detection units (246-1 or 246-2), which is then defined only in one of the two polarization states of the predefined polarization base processed by the analysis device DA. Each detection unit (246-1 and 246-2) is thus configured to detect the light energy relative to one of the two polarized sub-components of the control component Rₘ so as to provide the estimate of the received control signal. For example and non-limitingly, according to this configuration, the value relative to the estimated control signal, measured by the first detection unit 246-1, may be at a maximum and the value measured by the second detection unit 246-2 may be at a minimum if the polarization state of the control component Rₘ is equal to the initial polarization state of the control signal under consideration transmitted by the transmitter. Conversely, the value relative to the estimated control signal, measured by the first detection unit 246-1, may be at a minimum and the value measured by the second detection unit 246-2 may be at a maximum if the polarization state of the control component Rₘ is orthogonal to the initial polarization state of the control signal under consideration transmitted by the transmitter.

For example and non-limitingly, an analysis device DA for analyzing the polarization of a received control component Rₘ associated with the H/V diagonal base may comprise a splitting unit 244-B configured to supply a first sub-component having an H-type linear polarization propagating on the transmission means 244-i1 and a second sub-component having a V-type linear polarization propagating on the transmission means 244-12. In this example, the two corresponding detection units 246-1 and 246-2 are therefore configured to respectively detect the sub-component relating to the H-type linear polarization of the control component Rₘ and the sub-component relating to the V-type linear polarization of the control component Rₘ.

In some embodiments, the one or more detection units (246, or 246-1 and 246-2) of an analysis device DA may be matched to the reference wavelength λ_{Rx} (that is to say λ_{R1} or λ_{R2}) of the control component Rₘ to be detected.

The intermediate receiver 20-m may furthermore comprise one or more processors (also called ‘central computing units’) or CPUs (central processing units).

In some embodiments, each analysis device DA of the receiver 20-m may comprise a specific processor, generally denoted 248, configured to analyze the one or more electrical signals from the one or more detection units (246, or 246-1 and 246-2) corresponding to the estimated control signal, associated with the analysis device DA. A processor 248 may be configured to generate a servo signal, denoted Sc, corresponding to a polarization correction setpoint signal to be delivered to the correction module 220 associated with the processing chain Cm.

In some embodiments, the intermediate receiver 20-m may comprise a single processor 248 configured to analyze all of the electrical signals from the detection units of the analysis devices of the receiver 20-m. In this case, the processor 248 may be configured to generate a servo signal S_{C} specific to each correction module 220 of a processing chain Cm.

A servo loop of a processing chain Cm (that is to say a polarization correction loop generating a servo signal) may be implemented continuously or intermittently. A processor 248 may thus be configured to control the one or more servo loops of the intermediate receiver 20-m. In particular, a servo loop may be activated periodically and/or after evaluation of the polarization state of one or both estimated control signals with respect to one or more associated polarization base polarization states. Moreover, a servo loop may be implemented until the polarization state of one or both estimated control signals is aligned with an associated chosen (or reference) polarization state and/or in a chosen polarization base.

In some embodiments, a processor 248 of the intermediate receiver 20-m may be configured to determine, for a specific correction device D, a polarization state difference value δP between the polarization state of the estimated control signal under consideration and the polarization state of the polarization base associated with the correction device D. The processor 248 may furthermore be configured to evaluate whether this polarization state difference value δP is strictly greater (or greater than or equal to) a predefined reference difference value δP_{ref}.

In particular, a servo loop may be activated if a determined polarization state difference value δP is greater than or equal to the reference difference value δP_{ref}.

Advantageously, a servo loop may be implemented so as to optimize (that is to say maximize or minimize) the detection of the component of the one or more control signals according to the one or more associated polarization states.

For example and non-limitingly, a servo signal of a servo loop may be generated using a differentiable optimization algorithm, such as a gradient descent algorithm, so as to search (incrementally or iteratively) for an optimum point of an objective function associated notably with the determined polarization state difference value of a correction device D of the receiver 20-m. If an optimum point is found, the servo loop may be stopped.

The servo loop may also be stopped, for example and non-limitingly, if a determined polarization state difference value δP is evaluated as being strictly less than (or less than or equal to) the reference difference value δP_{ref}.

Thus, in some embodiments, a servo signal S_{C} relating to the setpoint signal of a correction module 220 may be generated so as to control this module 220 and notably to rotate the polarization of the received multiplexed signal until the value of the estimated control signal, measured by the detection unit 240 (for example via the first detection unit 246-1), is optimum, that is to say the polarization state of the control component Rₘ is then equal to the initial polarization state of the control signal under consideration transmitted by the transmitter, or alternatively orthogonal thereto. The modification of the polarization of the multiplexed signal received via the servo signal Sc thus induces a modification of the polarization state of the quantum signal Qₘ demultiplexed from the signal Sₘ at the output of the unit 242, and conveyed to the correlation module 260 of the receiver 20-m.

Moreover, the detection units of the correlation module 260 of an intermediate receiver 20-m may be single-photon detection units. The detection of the quantum components Qₘ₁ and Qₘ₂ makes it possible to supply at least one entanglement information signal Iₘₖ to be supplied respectively to an end receiver 30-k of the third set of devices 30 of the system 1.

In some embodiments, a correlation module 260 of an intermediate receiver 20-m may comprise, at input, one or two additional demultiplexing units (not shown in the figures). Each additional demultiplexing unit of the correlation module 260 is associated with one of the quantum components Qₘ₁ or Qₘ₂ and may be equivalent to the signal demultiplexing unit 242 of the detection module 240 of a processing chain Cm, and configured to transmit the quantum component under consideration to the Bell measurement module, for example. The one or more residual components of the control signals from the demultiplexing unit are then directed to a beam absorber.

The additional demultiplexing unit of the correlation module 260 may notably comprise a demultiplexing element determined as a function of the type of multiplexing of the signal Sₘ. For example, for frequency division multiplexing, the additional demultiplexing unit may be a spectral filter configured to separate a quantum signal Qₘ from the two residual components of the integrated signals, such as an FBG filter or an add/drop WDM filter, and chosen based on the predetermined frequency difference between the quantum wavelength λ_{Q} and the reference wavelengths (λ_{R1} and/or λ_{R2}).

Such an additional demultiplexing unit in the correlation module 260 makes it possible notably to increase the filtering capacity for filtering the one or more control signals from the one or more multiplexed signals received at the input of the intermediate receiver 20-m, in order to improve the quantum correlation measurement carried out by the module 260.

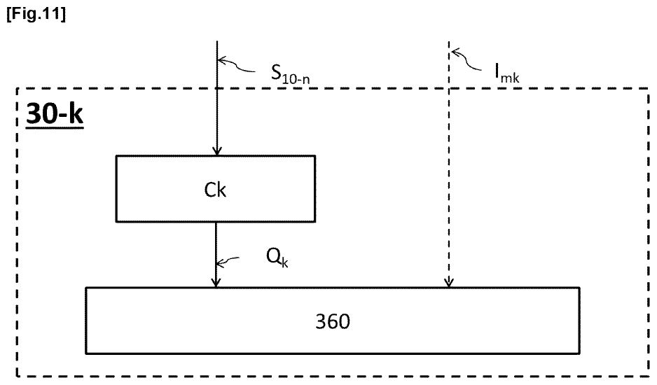

FIG. 11 schematically shows an end receiver 30-k comprising a received multiplexed optical signal processing chain, and a quantum photon analysis module 360, according to some embodiments. In this case, the end receiver 30-k may be configured to receive a transmission optical signal that is a multiplexed signal S₁₀₋ₙ transmitted by a transmitter 10-n of the first set of devices 10. Such a signal may for example be the multiplexed signal S₁₀₋ₙ₂ comprising a quantum signal Qₙ₂ and a first control signal Rₙ₁ and/or a second control signal Rₙ₂.

A processing chain of an end receiver 30-k, denoted Ck, may be configured to receive a multiplexed optical signal and deliver a received quantum signal Qₖ relating to the quantum signal originating from the multiplexed signal S₁₀₋ₙ. The quantum photon analysis module 360 of an end receiver 30-k may be designed to measure the received quantum signal, according to at least one polarization state defined in a polarization base.

The processing chain Ck may be designed to determine the polarization state of the one or more control signals originating from the multiplexed optical signal received by the end receiver 30-k. The processing chain Ck may furthermore be designed so as to align this determined polarization state with one of the predefined measurement polarization states of the analysis module 360. The processing chain Ck may thus be designed to rotate the polarization state of all of the signals originating from the received multiplexed optical signal, at the input of the processing chain Ck, so as to ensure that the particles of the received quantum signal Ck at the output of the processing chain Ck are correctly aligned in the polarization base associated with the analysis module 360. The processing chain Ck may thus be equivalent (comprise similar units) to a processing chain Cm of an intermediate receiver 20-m, as illustrated in FIG. 8.

In particular, the processing chain Ck of an end receiver 30-k may comprise a servo loop between a polarization state correction module arranged upstream of a control signal detection module.

The correction module of the processing chain Ck (equivalent to the correction module 220 of a processing chain Cm of a receiver 20-m) may be configured to modify the polarization of a signal passing through it, in response to a setpoint signal. The correction module is therefore configured to receive a multiplexed optical signal S₁₀₋ₙ received by the end receiver 30-k (for example S₁₀₋ₙ₂ transmitted by a first transmitter 10-n) and to deliver a polarization-modified multiplexed optical signal, denoted Sₖ for example.

The detection module of the processing chain Ck (equivalent to the correction module 240 of a processing chain Cm of a receiver 20-m and thus illustrated in FIGS. 9 and 10) may comprise a signal demultiplexing unit and at least one analysis device for analyzing the polarization of the control signal. The demultiplexing unit may be configured to separate the polarization-modified multiplexed optical signal into at least one received quantum signal component Qk, which is then conveyed to the quantum photon analysis module 360. An analysis device for analyzing the polarization of the control signal in the processing chain Ck may be configured to process a received control signal component originating from the polarization-modified multiplexed optical signal, notably to generate a servo signal corresponding to the polarization correction setpoint signal to be delivered to the correction module of the processing chain Ck.

In embodiments in which an end receiver 30-k is configured to receive a transmission optical signal comprising only a quantum signal (that is to say a signal that is not multiplexed), the transmission optical signal S₁₀₋ₙ then corresponds directly to the received quantum signal Qₖ to be processed by the analysis module 360.

The analysis module 360 of an end receiver 30-k may comprise at least one single-photon detection unit. The detection of the received quantum signal Qₖ makes it possible to supply the estimated received quantum signal S_{Qk} and thus an estimate of the polarization state of the signal with respect to one or more polarization states defined in a polarization base.

In some embodiments, the analysis module 360 may comprise a single single-photon detection unit 366 configured to detect the received quantum signal Qₖ, defined according to a predetermined polarization state.

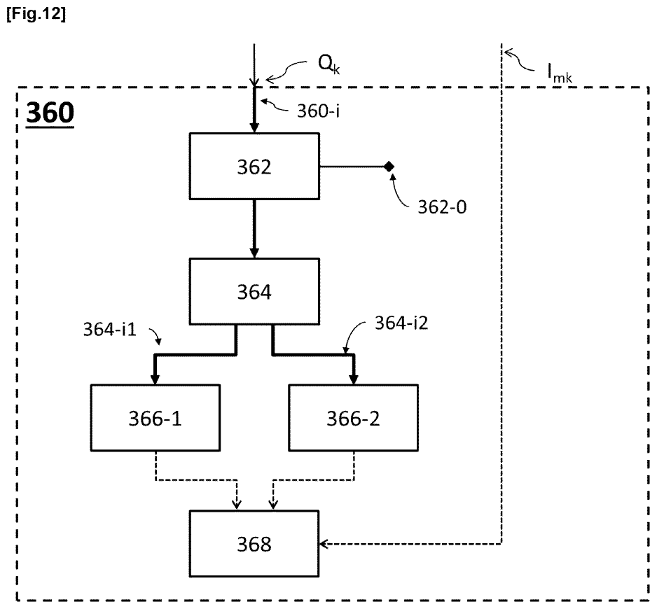

In other embodiments, as shown in FIG. 12, the analysis module 360 may comprise a switching unit 364, preceded by two single-photon detection units 366-1 and 366-2. The switching unit 364 may be equivalent to the polarized-beam splitting unit 244-B of an analysis device DA contained in an intermediate receiver 20-m. The switching unit 364 may therefore be designed to direct (that is to say route or switch) the quantum signal Qₖ demultiplexed from the multiplexed signal S₁₀₋ₙ received at the input of the end receiver 30-k to one of the two single-photon detection units (366-1 or 366-2) as a function of the polarization state of the quantum signal. Each single-photon detection unit (366-1 and 366-2) is thus configured to detect the presence of single photons defined according to one of the polarization states of the polarization base, processed by the analysis module 360 (that is to say the end receiver 30-k under consideration).

By way of illustration, an analysis module 360 associated, for example and non-limitingly, with the H/V base may comprise the switching unit 364 configured to direct the received quantum signal Qₖ having a horizontal H-type linear polarization to the first single-photon detection unit 366-1 via the transmission means 364-i1, or to direct the received quantum signal Qₖ having a vertical V-type polarization to the second single-photon detection unit 366-2 via the transmission means 364-12.

In embodiments in which the transmission optical signal S₁₀₋ₙ received by the end receiver 30-k is a multiplexed signal, the analysis module 360 may comprise, at input, an additional demultiplexing unit 362, equivalent to a signal demultiplexing unit 242 of a processing chain Cm, or to an additional demultiplexing unit of the correlation module 260, contained in an intermediate receiver 20-m. The additional demultiplexing unit 362 may thus be configured to transmit the received quantum signal Qₖ to the single-photon detection unit 366, or to the switching unit 364, as shown in FIG. 12. The residual components of the control signals are then directed to a beam absorber 362-0, as shown in FIG. 12.

Moreover, the analysis module 360 of an end receiver 30-k may comprise a processor 368 configured to analyze the one or more electrical signals from the one or more detection units (366, or 366-1 and 366-2) corresponding to the estimated received quantum signal S_{Qk}. The processor 368 of an end receiver 30-k may be configured to determine a quantum encryption key, that is to say a key shared with the other by the end receiver 30-q, from the estimated received quantum signal S_{Qk} and from the entanglement information signal Iₘₖ received by the end receiver 30-k.

A quantum encryption key may be determined using a quantum key distribution protocol, such as for example a protocol comparable to the protocol called BBM92 (as described in the Article “Quantum cryptography without Bell's theorem” by C. Bennett, G. Brassard and D. Mermin, 1992, Physical Review Letters 68 (5), p. 557-559).

In some embodiments, such as for example when the control signals are quantum signals and the multiplexed signal received by the end receiver 30-k is a time-multiplexed signal, the processing chain Ck may be constituted by a polarization state correction module and at least part of the analysis module 360. In this case, the module 360 configured to detect the received quantum signal Qₖ may furthermore be configured to detect one or more of the control signals originating from the multiplexed optical signal received by the end receiver 30-k. In this case, the processor 368 may also be configured to generate a servo signal corresponding to a polarization correction setpoint signal to be delivered to the correction module of the processing chain Ck.

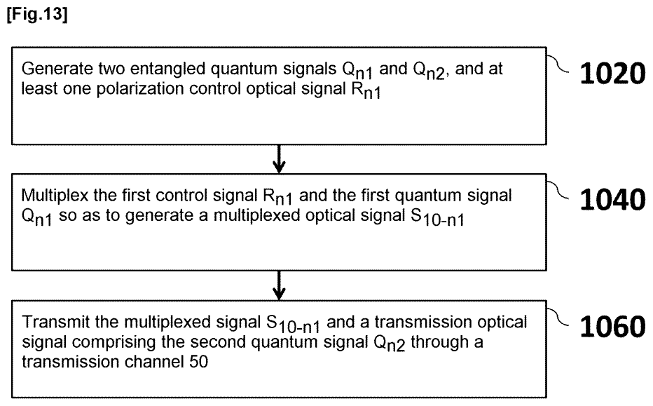

FIG. 13 shows the method for transmitting optical signals, implemented by a transmitter 10-n, according to some embodiments of the invention.

The method for transmitting optical signals comprises a preliminary step 1020 of generating two entangled quantum signals Qₙ₁ and Qₙ₂, as well as at least one polarization control optical signal Rₙ₁.

In step 1040, the polarization control optical signal Rₙ₁ is inserted onto the optical path transporting the first entangled quantum signal Qₙ₁ so as to generate a multiplexed optical signal S₁₀₋ₙ₁.

In step 1060, the multiplexed optical signal S₁₀₋ₙ₁ and a transmission optical signal comprising the second quantum signal Qₙ₂ are transmitted through a transmission channel 50.

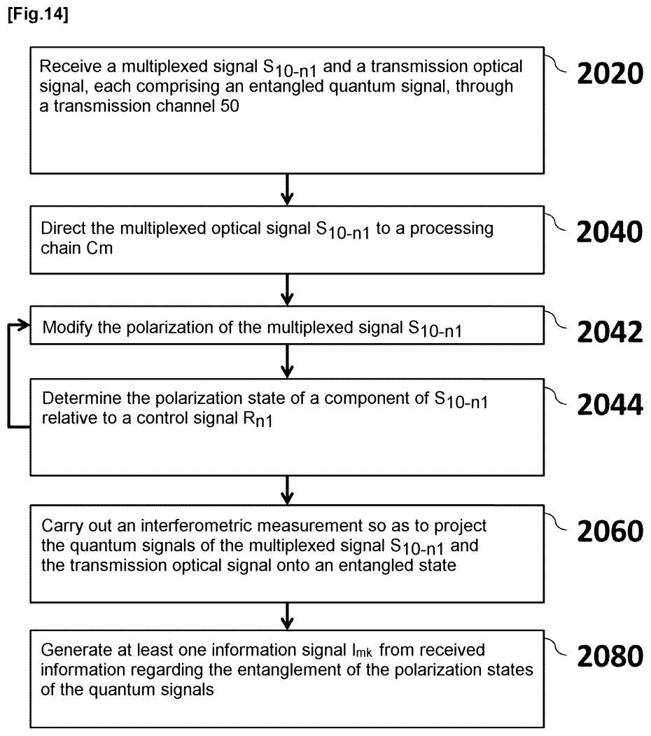

FIG. 14 shows the method for the intermediate reception of optical signals, implemented by an intermediate receiver 20-n, according to some embodiments of the invention.

The reception method comprises a preliminary step 2020 of receiving a multiplexed optical signal S₁₀₋ₙ (or S₁₀₋ₙ₁) and a transmission optical signal, each comprising an entangled quantum signal that is transmitted independently, respectively by two distinct transmitters, and transmitted through a transmission channel 50.

In step 2040, the multiplexed optical signal S₁₀₋ₙ₁ is directed to a processing chain Cm, associated with a predefined polarization base.

The method for the intermediate reception of optical signals furthermore comprises, for the processing chain Cm, a servo loop between steps 2042 and 2044. Step 2044 corresponds to determining the polarization state of a component of the received multiplexed optical signal passing through the chain and relative to a control signal Rₙ₁ transmitted by the transmitter 10-n, and step 2042 corresponds to modifying the polarization of the received multiplexed optical signal as a function of the determined polarization state. The servo loop between steps 2042 and 2044 is stopped when the polarization state determined in step 2044 is aligned with respect to one of the polarization states of the predefined base for the processing chain Cm.

In step 2060, an interferometric measurement is carried out so as to project, onto an entangled polarization state (relative to a measurement polarization base), the particles associated respectively with the quantum component of the received multiplexed optical signal relating to the entangled quantum signal Qₙ₁, and to the entangled quantum signal originating from the received transmission optical signal.

In step 2080, at least one information signal Iₘₖ is generated from information regarding the entanglement of the determined polarization states of the received quantum signals, and then transmitted through a transmission channel 50.

FIG. 14 shows the method for the final reception of optical signals, implemented by an end receiver 30-n, according to some embodiments of the invention.

In some embodiments, the method for the final reception of optical signals may comprise a preliminary step 3020 of receiving a multiplexed optical signal S₁₀₋ₙ (or S₁₀₋ₙ₂) comprising an entangled quantum signal transmitted by a transmitter, as well as an information signal Iₘₖ regarding the entanglement of the polarization state of quantum signals, transmitted through a transmission channel 50.

In step 3040, the multiplexed optical signal S₁₀₋ₙ₂ may be directed to a processing chain Ck, associated with a predefined polarization base.

The method for the final reception of optical signals may furthermore comprise, for the processing chain Ck, a servo loop between steps 3042 and 3044. Step 3044 corresponds to determining the polarization state of a component of the received multiplexed optical signal passing through the chain and relative to a control signal Rₙ₁ transmitted by the transmitter 10-n, and step 3042 corresponds to modifying the polarization of the received multiplexed optical signal as a function of the determined polarization state. The servo loop between steps 3042 and 3044 is stopped when the polarization state determined in step 3044 is aligned with respect to one of the polarization states of the predefined base for the processing chain Ck.

In step 3060, the polarization state of the quantum component of the received multiplexed optical signal relative to the entangled quantum signal Qₙ₂ may be determined.

In step 3080, a quantum encryption key, shared with another end receiver 30-q, may be determined based on the polarization state of the quantum component of the received multiplexed optical signal relative to the entangled quantum signal Qₙ₂ and the information regarding the entanglement of the polarization states of the quantum signals derived from the information signal Iₘₖ.

Those skilled in the art will readily understand that some steps of the transmission and reception methods may respectively be carried out simultaneously, sequentially, independently or otherwise, and/or in a different order, for example in an order defined by a transmitter and a receiver under consideration.

The quantum system or the subsystems of the system (transmitters and receivers), along with the methods described above, according to the embodiments of the invention, may be implemented in various ways by hardware, or a combination of hardware and software, notably in the form of program code that may be distributed as a program product, in various forms. The program code may be distributed using computer-readable media, which may include computer-readable storage media and communication media. The methods described in the present description may be implemented notably in the form of computer program instructions able to be executed by one or more processors in a computer-based computing system. These computer program instructions may also be stored in a computer-readable medium.

The invention is not limited to the embodiments described above by way of non-limiting example. It encompasses any variant embodiments that might be envisaged by those skilled in the art. In particular, those skilled in the art will understand that the invention is not limited to the various modules of the transmitters and receivers of the quantum system that have been described by way of non-limiting example.

1. A receiver configured to receive a multiplexed optical signal (S₁₀₋ₙ) and an optical signal (S₁₀₋ₕ) that are transmitted independently through a transmission channel, said multiplexed optical signal (S₁₀₋ₙ) comprising a first quantum signal (Qₙ), said optical signal (S₁₀₋ₕ) comprising a second quantum signal (Qₕ), said multiplexed optical signal (S₁₀₋ₙ) furthermore comprising at least one polarization state control signal (Rₙ₁), said receiver comprising a processing chain (Cm) associated with a polarization base composed of at least one polarization state and designed to determine the polarization state of said at least one polarization state control signal (Rₙ₁) and to modify the polarization of said multiplexed optical signal (S₁₀₋ₙ) so as to align said determined polarization state with respect to one of said at least one polarization state of said associated base, said receiver (20-m) furthermore comprising a correlation module designed to carry out a correlation measurement between said first quantum signal (Qₙ₁) originating from said polarization-modified multiplexed optical signal (S₁₀₋ₙ) and said second quantum signal (Qₕ), said correlation module being associated with said polarization base, said correlation module furthermore being designed to generate at least one information signal (Iₘₖ) based on said correlation measurement, said information signal (Iₘₖ) comprising information regarding the entanglement of the polarization states of said first and second quantum signals (Qₙ, Qₕ).

2. The receiver according to claim 1, wherein said processing chain (Cm) comprises a control signal detection module and an analysis device, the control signal detection module being configured to demultiplex said at least one control signal (Rₙ₁) and said first quantum signal (Qₙ) from said multiplexed optical signal (S₁₀₋ₙ), said detection module furthermore being configured to convey said demultiplexed control signal (Rₙ₁) to the polarization analysis device (DA), the polarization analysis device (DA) comprising at least one detection unit designed to detect said control signal (Rₙ₁) according to one of said at least one polarization state of said associated base.

3. The receiver according to claim 2, wherein said detection module furthermore comprises a processor configured to analyze said determined polarization state and to generate a servo signal (S_{C}) applied to a polarization correction module for correcting the polarization of said multiplexed optical signal (S₁₀₋ₙ).

4. The receiver according to claim 1, wherein said receiver is formed from polarization-maintaining fibers (PMF) and/or single-mode optical fibers (SMF).

5. A transmitter configured to transmit optical signals, comprising:
a signal generator configured to generate a first quantum signal (Qₙ₁), a second quantum signal (Qₙ₂) and a polarization state control signal (Rₙ₁), said first quantum signal (Qₙ₁) and said second quantum signal (Qₙ₂) being quantum signals entangled with one another,
a signal integrator configured to generate a multiplexed optical signal (S₁₀₋ₙ₁), the multiplexed signal comprising said first control signal (Rₙ₁) and said first quantum signal (Qₙ₁),
said transmitter being configured to transmit said multiplexed optical signal (S₁₀₋ₙ₁) and an optical signal (S₁₀₋ₙ₂) comprising said second quantum signal (Qₙ₂) through a transmission channel.

6. A quantum communication system comprising a plurality of transmitters configured to transmit optical signals, each transmitter comprising:
a signal generator configured to generate a first quantum signal (Qₙ₁), a second quantum signal (Qₙ₂) and a polarization state control signal (Rₙ₁), said first quantum signal (Qₙ₁) and said second quantum signal (Qₙ₂) being quantum signals entangled with one another,
a signal integrator configured to generate a multiplexed optical signal (S₁₀₋ₙ₁), the multiplexed signal comprising said first control signal (Rₙ₁) and said first quantum signal (Qₙ₁),
said transmitter being configured to transmit said multiplexed optical signal (S₁₀₋ₙ₁) and an optical signal (S₁₀₋ₙ₂) comprising said second quantum signal (Qₙ₂) through a transmission channel, and
the system further comprising at least one receiver according to claim 1.

7. The system according to claim 6, wherein said plurality of transmitters comprises at least a first transmitter and a second transmitter, and said system furthermore comprises a plurality of auxiliary receivers comprising a first auxiliary receiver configured to receive an optical signal (S₁₀₋ₙ) comprising a quantum signal (Qₙ) transmitted by the first transmitter, and a second auxiliary receiver configured to receive an optical signal (S₁₀₋ₕ) comprising a quantum signal (Q) transmitted by the second transmitter, each auxiliary receiver being associated with a measurement polarization base composed of at least one polarization state and designed to measure said associated quantum signal (Qₙ; Qₕ) according to at least one of said at least one polarization state of said associated measurement polarization base, and wherein each auxiliary receiver is configured to receive an entanglement information signal (Iₘ₁; Iₘ₂ or Iₚ₂) comprising information regarding the entanglement of polarization states of quantum signals transmitted by said at least one receiver, each auxiliary receiver being configured to determine a shared quantum encryption key based on said measurement of said associated quantum signal (Qₙ; Qₕ) and said information regarding the entanglement of polarization states of quantum signals.

8. The system according to claim 7, wherein, for one or both auxiliary receivers, said optical signal (S₁₀₋ₙ; S₁₀₋ₕ) received by said auxiliary receiver is a multiplexed optical signal furthermore comprising a polarization state control signal (Rₙ₁), said one or more auxiliary receivers comprising a processing chain (Ck) associated with said measurement polarization base and designed to determine the polarization state of said polarization state control signal (Rₙ₁) and to modify the polarization of said multiplexed optical signal (S₁₀₋ₙ; S₁₀₋ₕ) so as to align said determined polarization state with respect to one of said at least one polarization state of said associated measurement polarization base.

9. The system according to claim 6, wherein said multiplexed signals are frequency-multiplexed signals.

10. The system according to claim 9, wherein the absolute value of the wavelength difference between the quantum wavelength (λ_{Q}) of a quantum signal and the reference wavelength (λ_{R}) of a control signal is greater than or equal to a minimum wavelength difference value (δλ).

11. A method for determining at least one information signal in response to the receipt of a multiplexed optical signal (S₁₀₋ₙ) and of an optical signal (S₁₀₋ₕ) that are transmitted independently through a transmission channel, said multiplexed optical signal (S₁₀₋ₙ) comprising a first quantum signal (Qₙ), said optical signal (S₁₀₋ₕ) comprising a second quantum signal (Qₕ), said multiplexed optical signal (S₁₀₋ₙ) furthermore comprising at least one polarization state control signal (Rₙ₁), said method comprising a processing phase (Cm), associated with a polarization base composed of at least one polarization state, for determining the polarization state of said at least one polarization state control signal (Rₙ₁) and for modifying the polarization of said multiplexed optical signal (S₁₀₋ₙ) so as to align said determined polarization state with respect to one of said at least one polarization state of said associated base, the method furthermore comprising a correlation step comprising measuring a correlation between said first quantum signal (Qₙ₁) originating from said polarization-modified multiplexed optical signal (S₁₀₋ₙ) and said second quantum signal (Qₙ), said correlation measurement being associated with said polarization base, said correlation step furthermore comprising generating said at least one information signal (Iₘₖ) based on said correlation measurement, said information signal (Iₘₖ) comprising information regarding the entanglement of the polarization states of said first and second quantum signals (Qₙ, Qₕ).
